(19) United States
(12) Patent Application Publication
(10) Pub. No.: US 2011/0087355 A1
(43) Pub. Date: Apr. 14, 2011

(54) METHOD AND SYSTEM FOR REVERSE ENGINEERING A PRODUCTION REQUEST IN A MES ENVIRONMENT

(75) Inventors: PAOLO COPELLO, RAPALLO (IT); ALESSANDRO RAVIOLA, GENOVA (IT)

(73) Assignee: SIEMENS AKTIENGESELLSCHAFT, MUNCHEN (DE)

(21) Appl. No.: 12/891,137

(22) Filed: Sep. 27, 2010

(30) Foreign Application Priority Data
Oct. 13, 2009 (EP) 09 172 850

(51) Int. Cl. G06F 19/00

(52) U.S. Cl. 700/103

(57) ABSTRACT

A method and a system for automatically generating a product production rule from a production request, include a reading module configured for reading production request data, a data filter module configured for selecting a set of data from the production request data, a treatment module configured for generating the product production rule, and a device for storing the product production rule.

### CROSS-REFERENCE TO RELATED APPLICATION

This application claims the priority, under 35 U.S.C. §119, of European Patent Application EP 09 172 850, filed Oct. 13, 2009; the prior application is herewith incorporated by reference in its entirety.

### BACKGROUND OF THE INVENTION

### Field of the Invention

The present invention relates generally to production requests in a Manufacturing Executing System (MES) environment and more specifically to a method and a system for reverse engineering a production request.

A production request is a request for producing an object, for example, a request for producing a car. This request is usually associated with different production phases and working steps. Depending on the market segment, each of these production phases may also include ongoing production phases, i.e. each production phase may repeatedly reveal at least one ongoing production phase in a Russian doll way. Each of these production phases is associated with the production of at least one part or piece of the object. If we keep the example of the car, the production phases, and also its ongoing production phases, correspond to the production of pieces of the car, such as the motor, main body, etc. The working steps then correspond to the assembly of the pieces. Each car production operation moreover involves tools, equipment, personnel, in other words, resources that intervene in a defined manner, according, for example, to temporal planning or to an evolution of the production phases, and which cooperate for the effective realization of the final object, i.e. the car in the present example.

The set of operations that have to be realized for the production of the requested object, such as the entire production phases and working steps, are described in rules called Product Production Rules (PPR). Thus, the PPR define the set of operations that are necessary for achieving the production request according to a knowledge of usable resources. Thus, these operations include materials, personnel, equipments, etc, that are dedicated to each production phase and working steps. For example, in the case of the production of a car, the PPR define which resources will be engaged for placing a motor in the main body of a car, i.e. which tools will be used, which personnel manage it and are responsible for it, and when this operation takes place in the production process from a chronological point of view, i.e. according to an organization of the working steps and production phases. In other words, the PPR are the recipe for producing a requested object. They are instructions for making the requested object in a way that satisfies the production request.

When a new product or object is developed, the usual way to produce the new object starts with the creation of PPR, followed, then, by the creation, from these PPR, of a production request. Before reaching an ideal production request that entirely reflects the customer or market requirements, the PPR might be submitted to one or several refinements according to the customer's wishes. The PPR is thus translated into a customer order, i.e. the production request, that might have the particularity to be executable by a MES. For example, when a process controller, in particular included in the MES, executes guidelines or instructions given in the PPR, the resulting object of the production satisfies the customer criteria. Usually speaking, the MES is an intermediate layer providing computing machines and software tools between an Enterprise Resource Planning (ERP) upper layer and a process line lower layer, generally including software tools for analysis management and software tools for productive process. The MES is based on the ISA (International Standard Association) standard S95 which defines how software tools may implement the productive process at plant floor level and how to communicate with it.

Each production request is specific to one product, i.e. an object satisfying the customer criteria. Moreover, a production request is the result of an integration of several and often mixed data sources involved in the production of a requested object. Effectively, the PPR, that define and plan the production phases and working steps from a chronological point of view, are linked to data sources of various origins, which represent, for example, the resources used for the production of the object. It might, for example, be external or internal data sources that are provided by a customer, by an ERP system, etc. The data are usually appropriately worked out in order to become integrable to at least one production request within the MES. The PPR are based on the data sources, and use the data sources for the creation/generation of a production request. Consequently, a production request is defined by a specific set of data resulting from an integration of at least a part of the data sources and is generally stored in a database modeling the production request. If the production request changes, the set of data involved in the production of the requested object also changes. Then, the MES associated with a specific plant is responsible for the execution of the production request generated by the PPR, i.e. for the production of the object associated with a product request.

PPR are very important in a factory, because they represent a model for generating the production request, with the model being free of any temporal deadlines associated with the production request, and being open to modifications for generating new production requests. Effectively, PPR are the theoretical instructions for a concrete production management associated with a production request. In order to execute a new production request, factory planers have to work on the PPR, and adapt it to new customer criteria associated with the new production request, and thus, to create new specific instructions. In particular, if the new production request is for example an evolution of a previously requested, and thus existing, object, the new instructions are only an adaptation of previously used instructions. Moreover, new products often start as an evolution of existing products already on the market. In this case, the evolution of the existing product requests a new PPR for generating and creating a new production request associated with the production of the new product.

One problem arises in reverse engineering of a production request, i.e. when one wants to abstract an existing production request into a PPR in order to be able to manipulate the PPR, for example for adapting the PPR to new requirements of a customer or market that are consistent with an evolution of an existing product. This case of reverse engineering starts from a known production request that was previously generated with unknown PPR, and aims to determine the unknown PPR that allow the creation of the existing production request. In other words, reverse engineering corresponds to finding the instructions, i.e. the PPR, associated with a known production request starting from the known production request.

Until now, when a production request arrived in a factory before any achievement of PPR, the only solution for creating rules from the production request was to manually perform an abstraction operation on the production request in order to obtain a model, i.e. the PPR. It often occurred that production requests were not turned into PPR, which was accompanied by lost data. Moreover, since a production request may include hundreds of production phases associated with a complex description of resources such as equipment, personnel, materials, process parameters, etc., manually abstracting instructions from a production request is consequently not trivial, and often also leads to lost time, accompanied by delay in the planning of a requested new product production.

### SUMMARY OF THE INVENTION

It is accordingly an object of the invention to provide a method and a system for abstracting a production request into PPR, in particular within a MES, which overcome the hereinafore-mentioned disadvantages of the heretofore-known methods and systems of this general type in a manner free of any manual operation related to the abstraction of the production request into the PPR.

With the foregoing and other objects in view there is provided, in accordance with the invention, a method for automatically generating PPR from a production request. The method comprises the steps of:
reading production request data, in particular the production request data being stored within a MES;
selecting a dataset from the production request data, in particular through the use of a filtering process of the production request data, the dataset being in particular a specific selection of the production request data according, for example, to filtering criteria that are satisfied;
sorting and working out the data of the dataset for generating at least one PPR, in particular by abstracting the data of the dataset; and
storing the generated PPR, such as in a memory, in particular in a database.

With the objects of the invention in view, there is also provided a system for automatically generating PPR from a production request. The system comprises:
a reading module capable of reading production request data, in particular capable of reading the production request data in a MES;
a data filter module constructed for selecting a set of data, or dataset, from the production request data according, for example, to a filtering process;
a treatment module constructed for generating the PPR, in particular by abstracting the data of the dataset; and
a device, such as a memory, for storing the PPR, in particular, in a database.

In particular, the production request data are data coming from at least one data source and being integrated to the production request.

In particular, the data filter module includes at least one filtering protocol constructed for allowing a selection of specific production request data that are needed for generating the PPR, with the selection being done according to filtering criteria. Thus, the filtering process is, in particular, constructed for working with at least one filtering protocol. Moreover, at least one filtering protocol is configurable by a device for configuring the filtering protocol, with the device for configuring being advantageously included in the data filter module. The configuration of the filtering protocols might be done manually by a user, for example by changing at least one filtering criterion, or automatically, in particular within a MES, and within the function of the type of object of the production request. Filtering the production request data results in the dataset, i.e. it results in a specific selection of the production request data that satisfies the filtering criteria.

The dataset, or in other words, the selection of specific production request data, includes in particular only non-temporal information related to the production request. Effectively, while the production request may include data related to production deadlines, such as the start of the production, the selection includes only non-temporal data, for example data related to resources such as material and equipment used for producing a requested object, but no information related to an estimated start time of the production of the requested object. Thus, the filtering process is able to automatically select at least one set of production request data solely related to production resources.

After filtering the production request data, the data included in the dataset are sorted and worked out, in particular by the treatment module, in order to generate the PPR. According to a preferred embodiment, the treatment module is capable of abstracting instructions and theoretical data from the data of the dataset. In particular, the expression “abstracting” means to withdraw data from their context, with the context being associated, for example, with the production of a specific requested object, so that data or instructions resulting from the abstracting process realized by the treatment module are free of any contextual information, i.e. are independent of a specific production request, and only include necessary information for realizing the requested object. Then, the data or instructions obtained after the abstracting process might be re-contextualized for each new specific production request, for example by being adapted to the requirements of a customer/market.

Other features which are considered as characteristic for the invention are set forth in the appended claims.

Although the invention is illustrated and described herein as embodied in a method and a system for reverse engineering a production request in a MES environment, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow diagram representing an example of a standard product lifecycle;

FIG. 2 is a flow diagram representing an example of a real product lifecycle;

FIG. 3 is a diagram representing an example of reverse engineering of a product request in a MES environment.

### DETAILED DESCRIPTION OF THE INVENTION

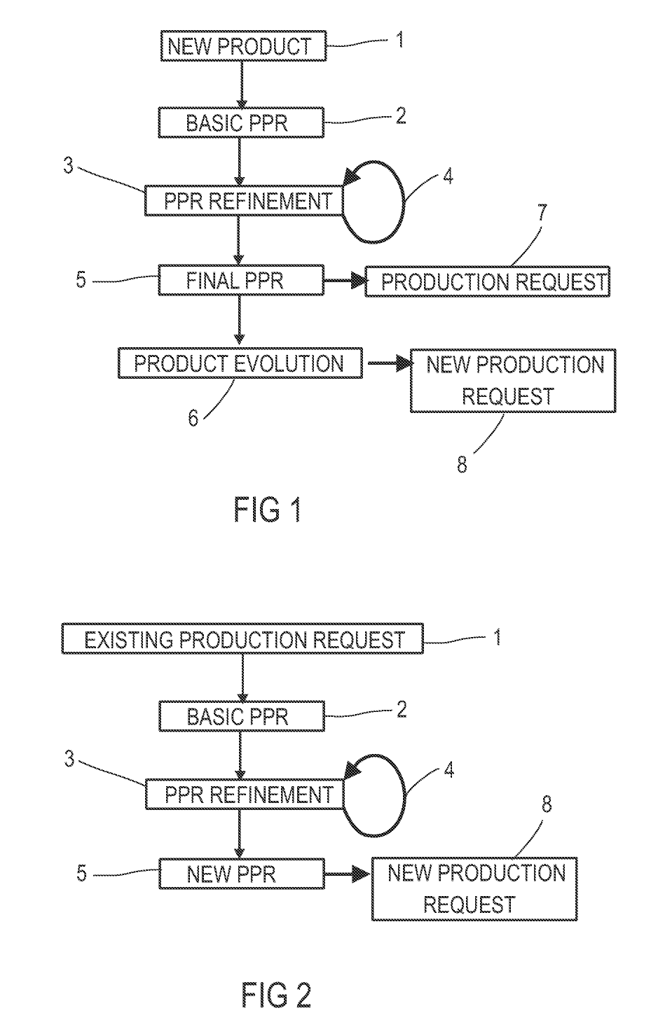

Referring now to the figures of the drawings in detail and first, particularly, to FIG. 1 thereof, there is seen a schematic representation of an example of a standard product lifecycle, according to a series of successive steps:
market or customer requirements identifying a new product in step 1;
generation of basic PPR in step 2 to produce the new product;
PPR refinements in step 3, i.e. subsequent refinements in step 4 of the basic PPR to obtain a final PPR in step 5 that is able to generate a production request in step 7 to produce the new product according to the market or customer requirements; and
subsequent refinements of the final PPR to adapt the final PPR to a product evolution in step 6, and thus, to obtain a new or similar PPR satisfying the requirements of the market or customer according to the evolution of the new product in step 1 and the creation of a new production request in step 8.

FIG. 2 schematically represents an example of a real product lifecycle, according to a series of successive steps:
an already existing product is associated with an existing production request in step 1 according to requirements of a market or customers;
manual generation of a basic PPR in step 2 representing an abstraction of the existing product; and
PPR refinements in step 3, i.e. subsequent refinements in step 4 of the basic PPR to obtain a new or similar PPR in step 5 for generating a new product associated with a new production request in step 8 satisfying the requirements of the customer or market.

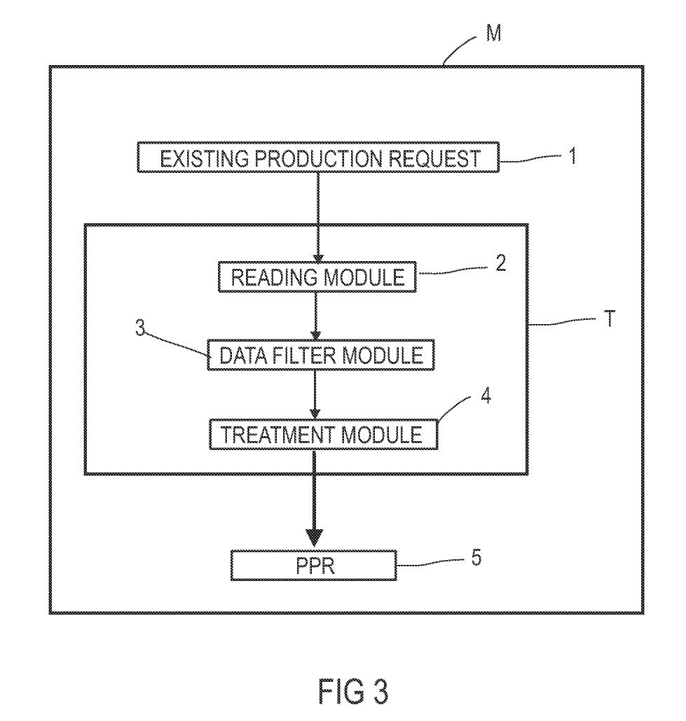

According to FIG. 2, new PPR have to be generated by hand starting from a known product that already exists in the market, but unknown PPR. The manual generation of a basic PPR is time-consuming and is often associated with economical loss. In order to avoid those problems, FIG. 3 schematically proposes an embodiment of the invention that allows the reverse engineering of a production request, in particular within a MES.

In FIG. 3, a reading module 2 is able to read production request data that are, for example, embedded or integrated to an existing production request 1 and stored in particular in a MES M. Then, a data filter module 3 is able to select among the production request data, a dataset including data that satisfy filtering criteria defined by at least one filtering protocol included in the data filter module. These filtering criteria allow, for example, only the selection of non-temporal data, or data related to resources such as material or equipment, or data related to production phases, etc., while other kinds of data are, for example, ignored. Once the selection of data satisfying the filtering criteria is done, then a treatment module 4 is able to generate at least one PPR 5, in particular by abstracting the data of the dataset. For example, the treatment module may, in particular, recognize production phases, working steps and resources (materials, equipments, . . . ) involved in the production request data, and withdraw them from their context that was specific to the existing product and thus, to the existing production request. The PPR 5 generated by the treatment module 4 might, in particular, be automatically stored in the MES M for future refinements according to an evolution of the product or customer/market requirements.

Finally, the reading module 2, the filter data module 3 and the treatment module 4 might be incorporated in a single reverse engineering tool T, in particular a plan for cooperating with a MES M.

Thus, the method and the system according to the invention have the following advantages:
the cooperation of the reading module 2, the data filter module 3 and the treatment module 4, allow the automatic generation of PPR from an existing production request 1; and
the automatic generation of PPR advantageously allows time and cost savings.

1. A method for automatically generating a product production rule from a production request, the method comprising the following steps:
reading production request data;
selecting a dataset from the production request data;
sorting and working out data of the dataset for generating at least one product production rule; and
storing the generated product production rule in a memory.

2. The method according to claim 1, which further comprises carrying out the step of selecting the dataset as a filtering process.

3. The method according to claim 2, which further comprises carrying out the filtering process for working with at least one filtering protocol.

4. The method according to claim 3, wherein the filtering protocol is configurable.

5. The method according to claim 2, which further comprises carrying out the filtering process by automatically selecting at least one set of production request data solely related to production resources.

6. The method according to claim 1, which further comprises abstracting the data of the dataset.

7. A system for automatically generating product production rules from a production request, the system comprising:
a reading module configured for reading production request data;
a data filter module configured for selecting a set of data from the production request data;
a treatment module configured for generating the product production rule; and
a memory for storing the product production rule.

8. The system according to claim 7, wherein said data filter module includes at least one filtering protocol.

9. The system according to claim 8, wherein said filtering protocol is configurable.

10. The system according to claim 7, wherein said treatment module is configured to generate at least one product production rule by abstracting the data of the data set.

11. The system according to claim 8, wherein said treatment module is configured to generate at least one product production rule by abstracting the data of the data set.
